(19) United States
(12) Patent Application Publication
(10) Pub. No.: US 2011/0056395 A1
(43) Pub. Date: Mar. 10, 2011

(54) PACKING FOR A DOCTOR BLADE CHAMBER

(76) Inventors: Erik Gydesen, Vejle (DK); Christian Fogh-Hansen, Bjert (DK)

(21) Appl. No.: 12/733,244

(22) PCT Filed: Jun. 19, 2008
(86) PCT No.: PCT/DK2008/050156

§ 371 Date: Apr. 29, 2010

(30) Foreign Application Priority Data
Aug. 21, 2007 (DK) PA-2007-01194

(51) Int. Cl. B41F 31/02

(52) U.S. Cl. 101/208

(57) ABSTRACT

A packing (4) for sealing a doctor blade chamber (3), where the packing (4) includes a sharp rail (7) for sealing abutment against a screen roller. The rail (7) is embedded in a resilient member (20) having a sealing surface (12) for bearing against the bottom (3A) of the doctor blade chamber at the side of the member opposite the sharp rail (7), and where a wall (11) extends from the sharp rail (7) and to the sealing surface (12). The wall (11) extends curving from the rail (7) to the sealing surface (12). By such a design of a gradual transition is achieved that corners in which ink may accumulate and where partial solidification may occur are avoided. The sealing surface (12) is convexly curving for continuous contact with the bottom (3A) of the doctor blade chamber, even by deformation of the sealing surface (12) under pressing action (9). Alternatively, or additionally, the wall (11) is running curving from the rail (7) to the sealing surface (12) for reduced deformation of the sealing surface (12) under pressure action (9).

### FIELD OF THE INVENTION

The present invention concerns a packing for separating ink chambers in a doctor blade chamber. Particularly, it concerns a packing for sealing a doctor blade chamber, where the packing includes a sharp rail for sealing abutment against a screen roller, where the rail is embedded in a resilient member having a sealing surface for bearing against the bottom of the doctor blade chamber at the side of the member opposite the sharp rail, and where a wall extends from the sharp rail to the sealing surface.

### DESCRIPTION OF PRIOR ART

In EP 401 250 is disclosed a doctor blade device which is represented in FIG. 1. The device includes a chamber bar with a U-shaped doctor blade chamber 3 with bottom 3A and sides 3B and 3C which during operation contain ink for a printing unit with a screen roller (not shown) which is in contact with the ink in the chamber 3. Two doctor blades 1, 2 are clamped to the chamber 3 by rails 5, 6, having the task of sealing against the screen roller, its surface being in contact with the ink in the chamber 3 Ink may be conducted into the chamber 3 via channels 8. Two channels 8 are shown, one for each part chamber in the chamber 3, wherein the part chambers are provided by delimiting by means of a packing 4 inside the chamber and a packing 4 at the end of the chamber. The packing 4 has a concave shape 4A for bearing against the screen roller.

Another prior art packing 4 is seen in FIG. 2 reproduced from EP 401 250 and which is four-sided in cross-section with vertical sides with horizontal lower edge and a curving top side which includes a concave centre part following the curvature of the screen roller. At the top side, there is a sealing means for achieving as good as possible sealing against the screen roller.

Another prior art type of packing is shown in FIG. 3. This packing has a rail 7 of a hard material for bearing against the screen roller for enhanced sealing. During operation, the screen roller is pressing against the rail 7, thereby also exerting a pressure against the elastic rubber packing 4. This pressure is transferred to the vertical sides of the packing.

The rail is disposed largely at right angles to an upper face of the packing. Thus there are sharp corners at the transition between the rail and the packing. This is particularly a problem at the ends of the rail in the space formed under doctor blades resting on the ends of the rail. In these corners, ink is very easily trapped, and deposits of semi-dry ink may be built up from this.

Detailed examination has revealed that these sides are pressed outwards thereby, causing the horizontal lower edges to spread, and in some cases letting go of the chamber bottom 3A. The problem is illustrated in FIG. 3, where FIG. 3A shows the packing 4 with the rail 7 in perspective view before pressing action, and FIG. 3B shows the packing 4 under pressing action 9, causing the wall 11 to slide outwards and deviate from its otherwise vertical orientation. This entails that not all of the contact surface 12 is sealing against the bottom 3A of the doctor blade chamber, as only its edge 13 is resting on the bottom 3A. This results in a leak in the packing.

Moreover, the pressure against the rail 7 and the deformation of the packing 4 produced thereby entail that the rail 7 slightly changes its curvature, thereby no longer sealing accurately against the screen roller any more. A small part of the ink may thereby slip past the packing, and typically it deposits as a viscous mass on the sides of the rail. Further increased pressure against the rail 7 and the deformation of the packing 4 produced thereby entails that the middle 14 of the wall 11 is lifted off the bottom 3A, and the rail 7 changes its curvature, thereby no longer sealing accurately against the screen roller any more.

The deformation of the packing in the above described way is thus a drawback which is desirous to improve.

For both types of prior art packings, there is a problem with a small amount of ink that can be trapped at the side of the sealing surface/rail. Hereby, there will appear an accumulation of ink which is partly dried and becomes viscous with gum-like characteristics. These accumulations of partly dried ink cause several problems. They may press against the rail and cause leakage, or they may come off and cause problems with the printing quality. By leakage, ink appears on the outer side of the packing, meaning that ink is running out of the chamber. The ink is accumulated at the outer side of the packing, where accumulations which are difficult to clean also appear.

In both cases it is a problem with these accumulations which are collected at the lip of the packing/the sharp rail in corners on sides of the doctor blade/chamber. For the design shown in FIG. 3 there is a risk of accumulation of relatively large amounts.

### PURPOSE OF THE INVENTION

It is thus the purpose of the invention to provide a packing that relieves the above mentioned disadvantages. In particular it is the purpose to provide a packing which relieves the problem with accumulations and which is more tight during operation.

### DESCRIPTION OF THE INVENTION

This purpose is achieved by a packing of the type mentioned in the introduction, which is peculiar in that the wall extends curving from the rail to the sealing surface at the bottom for forming a gradual transition from at least one side of the rail for avoiding sharp corners where ink may accumulate.

By such a design of a gradual transition is achieved that corners in which ink may accumulate and where partial solidification may occur are avoided. The packing appears with a sharp point in the shape of the rail. There will be a gradual increase of the thickness of the packing from the rail to the bottom. It may be compared with the action of a snowplough where the ink is forced outwards and away from the packing.

At the inner side of the packing inside the chamber, this means that the ink cannot solidify but is continually conducted back to the ink circulating through the chamber. Problems with lumps in the ink are hereby avoided.

At the outer side of the packing, possible ink which may penetrate past the packing may easily press previously leaked and solidified ink away along the packing as it has a gradually increasing thickness causing that the ink cannot accumulate in sharp corners.

It is thus possible to operate with very long periods of running between stops, and when the doctor blade chamber is to be cleaned, this is effected much more easily. Also, the time for exchange between various doctor blade chambers is reduced as the system is more clean, and thereby there is only need for a very reduced cleaning.

Moreover, a reduction in solidified ink will reduce waste/consumption of ink.

According to a special embodiment, the packing according to the invention is peculiar in that the sealing surface is convexly curving for continuous contact with the bottom of the doctor blade chamber even by deformation of the sealing surface under pressing action, and/or that the wall extends curving from the rail to the sealing surface for reduced deformation of the sealing surface under pressure action.

In that the sealing surface is convexly curving, a sealing against the bottom of the doctor blade chamber is also achieved under pressing action on the packing by the screen roller. More close analysis has shown that pressure action is particularly producing a leak, because the contact surface in packings of the prior art are deformed so much that they slide sideways and change the angle in relation to the bottom of the doctor blade chamber. In the packings of the invention, the curving contact face compensates for such a change in angle, thereby keeping the sealing contact with the bottom of the doctor blade chamber.

Another solution to the same problem is provided in that the wall extends curving from the rail to the sealing surface for reduced deformation of the sealing surface under pressing action. It has appeared that the pressure in such curving walls propagates more evenly in direction towards the sealing surface, whereby sliding is substantially reduced compared with the prior art, thereby providing a far better sealing against the bottom of the doctor blade chamber by pressing action.

These two solutions may advantageously be combined.

In practice, it has appeared that the rail is sealing so well that ink is no longer leaking past the rail under pressure in amounts that in practice would be of any nuisance. The rail is advantageously provided with a thin low friction blade, e.g. with a thickness of 1 mm. Due to the low friction, the heat development is minimal, also contributing to the ink not drying up so rapidly around the rail.

If a minimal ink leakage occurs, then the narrow sealing surface will cause the least possible depositing of semi-dry ink (gum).

By making the packing with tapering shape against the rail, there is achieved a snow plough effect ensuring that semi-dry ink (gum) is conducted away from the roller in a secure and simple way without influencing the doctor blade and sealing as explained above.

Moreover, making the packing with a surface or coating of low friction material will contribute to prevent the semi-dry ink from adhering and giving rise to lump formation.

By making the rail with a certain flexibility, there is achieved optimal contact with the roller and thereby optimal sealing.

There is thus a number of advantages connected with the packing according to the invention, e.g. longer running time between machine stops and easier cleaning, which also reduce the costs of maintenance.

Even though in principle it is possible that the resilient member just has a gradual transition in its wall against the closed chamber, it is preferred that the resilient member has two uniform walls arranged reversed opposite each other. These form e.g. a cavity between two sealing surfaces.

In a preferred embodiment, the inner sides of the walls extend concavely curving. They extend particularly in a way similar to the hull of a ship. The outer sides of the walls may thus extend convexly curving. By loading, the walls are deformed, where the upper part of the wall forms outward directed shoulders during the loading, which to a large degree maintains the direction of the pressing force at right angles to the bottom of the doctor blade chamber. This maintaining of the direction of the pressing force through the wall also causes—contrary to the prior art—that the sidewall is not lifted off the bottom.

It is not necessary that the outer side of the wall extends convexly over the entire length between the rail and the sealing surfaces. The outer side of the wall may, for example, extend concavely curving at the part of the wall which is closest to the rail and extend convexly curving at the part of the wall which is closest to the sealing surface.

The walls of the elongated member may advantageously be of thicker material at their ends than at the middle of the wall. This thickness variation has appeared to be a further advantage by pressure loads in order to prevent that the middle of the walls are bending upwards. In case that the thinner middle part of the walls extends right down to the sealing faces, this also means that the sealing faces are narrower at the middle than at the ends of the elongated member.

In order to provide a more rigid member, the walls may be connected by reinforcements extending through the cavity from one wall to the other opposing wall. Such reinforcements are e.g. plate-shaped, preferably designed as frames, and an integrated part of the member, possibly moulded of the same material as the walls.

The rail may also be designed such that it is not twisted skew under pressure action in parallel with the rail, e.g. by being broken into sections which make it bendable in direction towards the sealing surfaces. In case that the walls form a cavity, the rail may suitably extend into the cavity and the sections may be provided in the part of the rail which is in the cavity.

The packing according to the invention may, similar to the prior art packing, be used for shutting off a chamber which is delimited by the roller, doctor blade, bottom and sides in a chamber bar and the packings. It is possible to dispose the packings arbitrarily in the longitudinal direction of the chamber bar for making a shorter or longer chamber.

A packing according to the present invention may advantageously be used in a system with tangential doctor blades as described in the Danish patent application filed simultaneously with the present application, and the contents of which are hereby incorporated by reference.

Particular embodiments of the packing may thus provide an efficient sealing against doctor blades in such a system.

### SHORT DESCRIPTION OF THE DRAWING

The invention is described in more detail with reference to the drawing, wherein:

FIG. 1 shows a doctor blade chamber according to prior art reproduced from EP 410 250;

FIG. 2 shows a packing according to prior art reproduced from EP 410 250;

FIGS. 3A+B show a draft of problems with a further packing according to prior art;

FIG. 4 shows a perspective view of a first embodiment of a packing according to the invention;

FIG. 5 shows a cross-section of the first embodiment A) without any pressing action and B) with pressing action;

FIG. 6 shows a draft of an improved embodiment with curving contact surfaces A) without any pressing action and B) with pressing action;

FIG. 7 shows a draft of a packing with straight sides and curving contact surfaces;

FIG. 8 shows the prior art where FIG. 8A illustrates the packing before pressing action, and FIG. 8B illustrates the packing under pressing action; and

FIG. 9 shows a draft of a packing with curving walls, curving contact surfaces and supports.

### DETAILED DESCRIPTION OF THE INVENTION

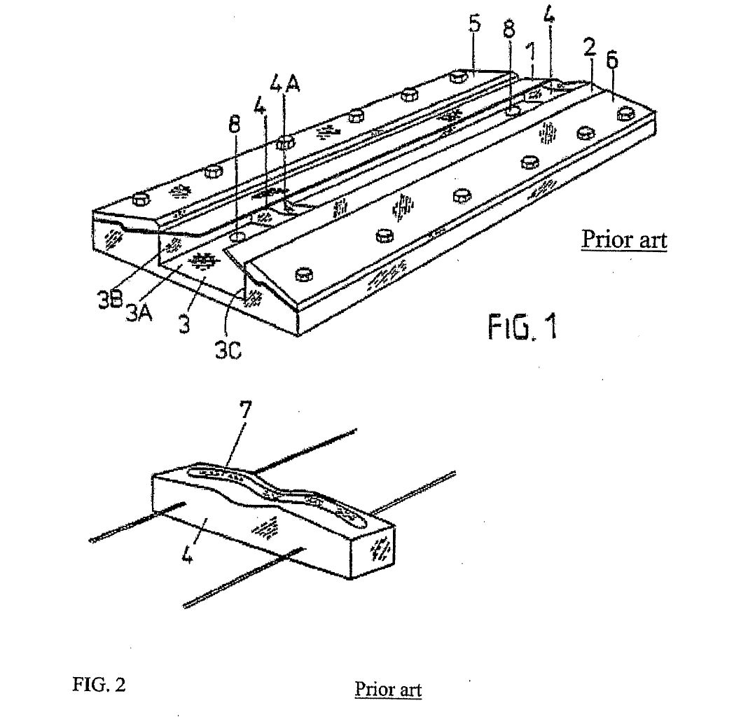

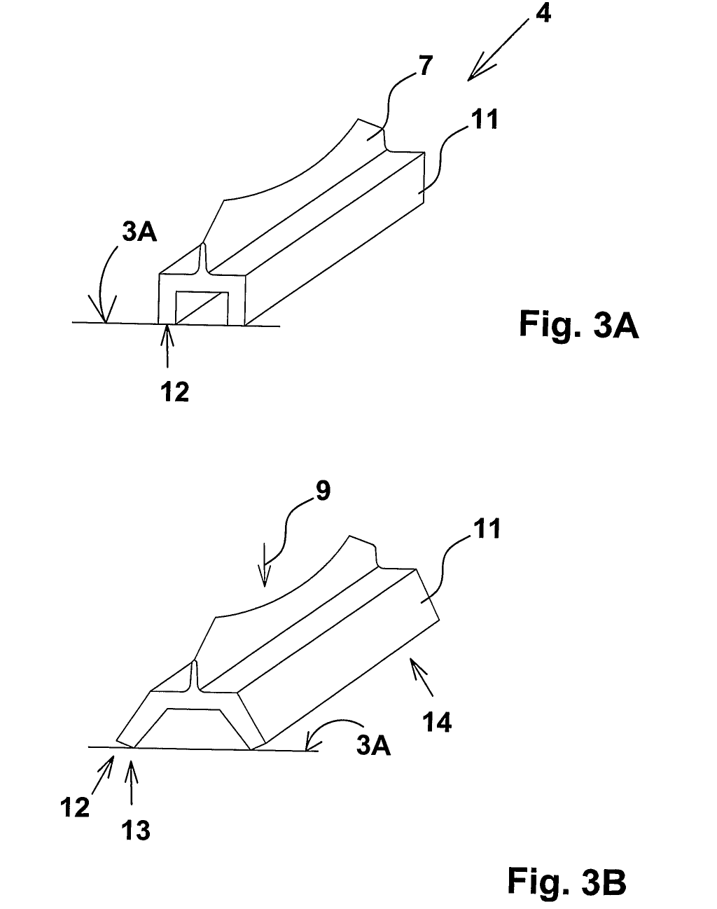

FIG. 1, FIG. 2 and FIGS. 3A+B are mentioned in the introduction as examples of prior art.

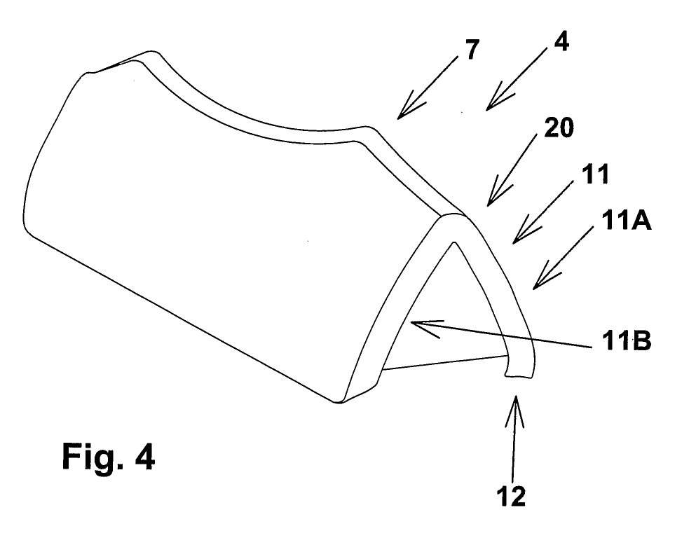

FIG. 4 shows a first embodiment of a packing according to the invention. The packing 4 has a rail 7 with a sharp edge, e.g. a blade of metal, carbon fibre or hard polymer, which is embedded in longitudinal direction of a resilient elongated member 20 with walls 11 extending curving from the rail 7 towards sealing surfaces 12. The wall 11 has a convex, smoothly curving outer side 11A. It appears thus clearly from the Figure that no corners appear wherein ink can accumulate. The packing 4 is made symmetrical such that there is no risk of faulty mounting.

The packing 4 has a concave, smoothly curving inner side 11B. The wall 11 reproduces a shape that is very similar to the shape of ship hulls. The sealing surfaces 12 are convexly curving for continuous contact with the bottom of the doctor blade chamber, even by deformation of the sealing surface under pressing action.

Firstly, the smoothly curving wall 11 causes that pressure is propagated more directly to the sealing surfaces, whereby the sidewall 11 is not pressed so much outwards as by packings according to prior art. Thus the sealing surfaces 12 do not slide so much sideways. Moreover, the sloping sealing surfaces mean that there is a satisfactory sealing against the bottom of the doctor blade chamber, even when the resilient member is deformed.

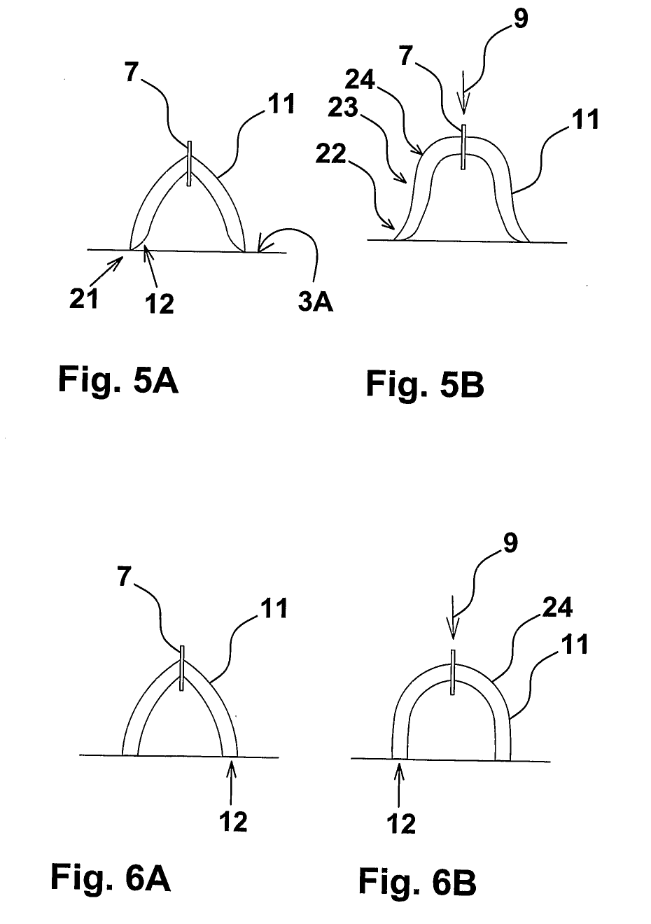

This is illustrated in greater detail in FIGS. 5A and 5B, where FIG. 5A shows the member of FIG. 4 in cross-section without load, and FIG. 5B shows the situation under load. With out any load as shown in FIG. 5A, the sealing surfaces 12 will primarily seal with their outermost edge 21 against the bottom 3A of the doctor blade chamber. Under load, the lowermost part 22 of the walls 11 will be deformed and slide slightly outwards, whereby the angle of the sealing surface against the bottom 3A is changed. Since the sealing surfaces 12 curve, they maintain good contact with the bottom 3A, also by relatively strong pressing action. Deformation of the wall 11, however, does not have as large influence on sliding of the lowermost part 22 of the wall as by the prior art, as the upper part 23 of the wall 11 forms shoulders 24 during the load, which to a large degree maintains the direction of the pressing action at right angles towards the bottom 3A of the doctor blade chamber. This maintaining of the direction of the pressing force through the wall 11 also causes—contrary to the prior art—that the sidewall 11 is not lifted off the bottom 3A.

This maintaining of the direction of the pressing action also means that by this ship-hull-like shape there is achieved an improvement compared with prior art, even if the sealing surfaces are straight and not curving, a fact illustrated on FIGS. 6A and 6B. As sliding of the wall 11 only appears to appreciable degree by larger pressing forces, the formed shoulders 24 will compensate for pressing action such that a sealing against the bottom 3A of the doctor blade chamber 3 is maintained at moderate pressing action 9 even if the sealing surfaces 12 are straight.

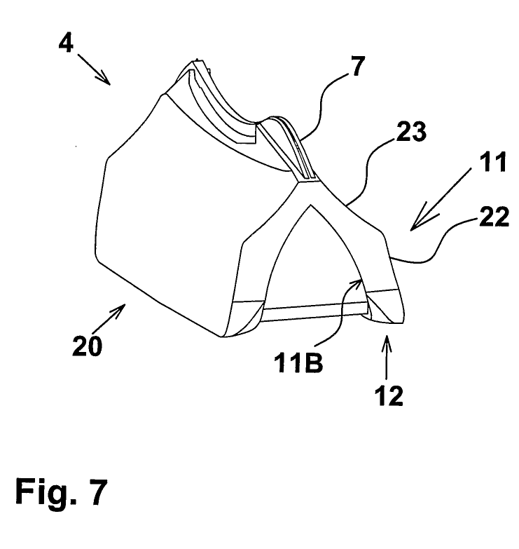

An alternative embodiment of a packing according to the invention is shown on FIG. 7. In that case, the outer wall 11A curves concavely on the upper part 23 of the wall, while it curves convexly on the lower part 22 of the wall. However, the wall curves smoothly concavely at the inner side 11B of the wall 11. Particularly the inner side 11B reproduces a shape which is very similar to the shape of ship hulls. Also, in this case the sealing surfaces 12 are convexly curving. The rail 7 is shown here with a curving shape at the outer ends for supporting doctor blades 1, 2. By suitable mutual disposition of screen roller and doctor blade chamber, these doctor blades may be pressed to a largely tangential orientation in relation to the screen roller with a curving course from their clamping between the chamber bar and the rails 5, 6 (see FIG. 1). As they have a curving course over the ends of the rail 7, a secure sealing is achieved.

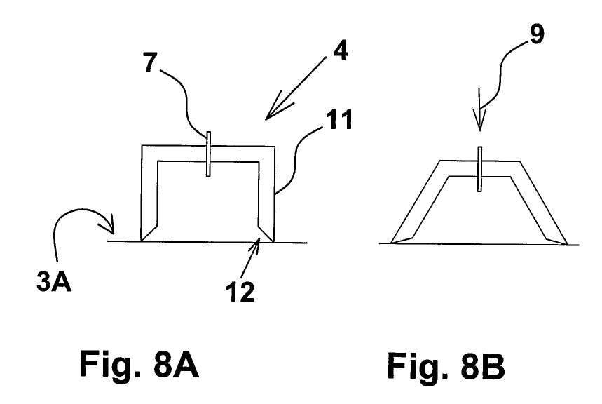

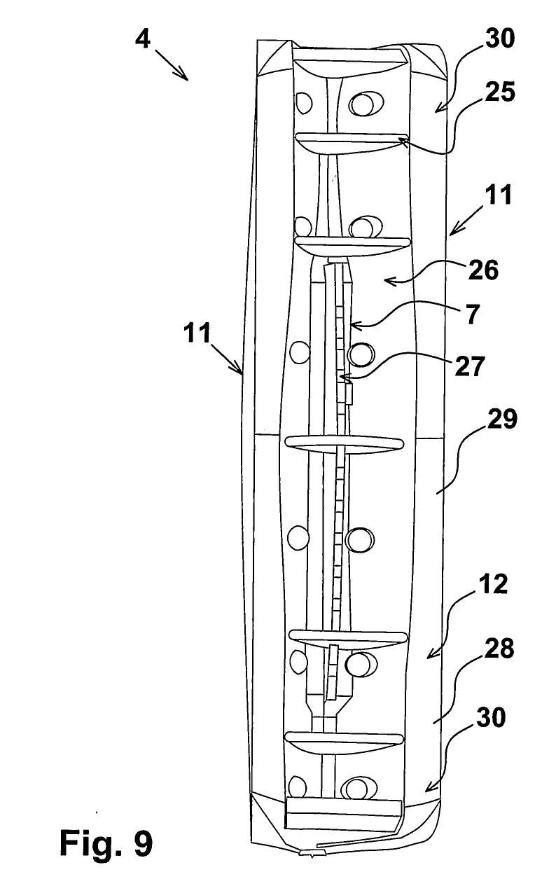

FIG. 8 shows that a packing according to prior art as described in the introduction may be improved by providing the packing 4 with curving contact surfaces 12. FIG. 8A illustrates the packing 4 before pressing action, and FIG. 8B shows the packing under pressing action 9. Even when the wall 11 slides, there will still be a sealing against the bottom 3A of the doctor blade chamber 3. There is no compensation for the wall 11 beginning to bend upwards at large pressures, as explained in the introduction in connection with FIG. 3B, which by this greater pressure provides a leak also by these curving contact surfaces 12. By great pressure, the embodiments described in connection with FIGS. 4 to 7 are better suited. However, at moderate pressure the sloping sealing faces 12 provide a significant improvement of the packings according to prior art as illustrated in FIG. 8B.

FIG. 9 shows the packing according to the invention as seen from below in an improved version, wherein the packing 4 is provided with transverse reinforcements 25 in the form of frames which prevent sliding of walls 11. Such reinforcements 25 are generally an advantage, and they may also be used as enhancing means for the packing 4 according to prior art shown in FIG. 3. The reinforcements 25 connect the walls 11 and are an integrated part of the resilient packing and e.g. provided by moulding in the same process as the walls 11 of the packing. Moreover, as illustrated in FIG. 9, the sharp rail is provided by a blade 7 extending a length down into the cavity 26 between the walls 11. The blade 7 is broken into sections 27 for by loading to be bent resiliently by pressure action in spite of its orientation in parallel with pressing action.

A further improvement of the sealing ability is achieved in that the walls 11 are thicker at the ends 28 than at the middle 29 of the wall, which is also illustrated by the fact that the sealing surfaces 12 are wider at their ends 30 than at the middle between the ends.

1. A packing (4) for sealing a doctor blade chamber (3), where the packing (4) includes a sharp rail (7) for sealing abutment against a screen roller, where the rail (7) is embedded in a resilient member (20) having a sealing surface (12) for bearing against bottom (3A) of the doctor blade chamber at the side of the member opposite the sharp rail (7), and where a wall (11) extends from the sharp rail (7) and to the sealing surface (12), wherein the wall (11) extends curving from the rail (7) to the sealing surface (12) at the bottom (3A) for forming a gradual transition from at least one side of the rail for avoiding sharp corners where ink may accumulate.

2. Packing according to claim 1, wherein the sealing surface (12) is convexly curving for continuous contact with the bottom (3A) of the doctor blade chamber even by deformation of the sealing surface (12) under pressing action (9), and that the wall (11) extends curving from the rail (7) to the sealing surface (12) for reduced deformation of the sealing surface (12) under pressure action (9).

3. Packing according to claim 1, wherein the inner side (11B) of the wall (11) extends concavely curving.

4. Packing according to claim 1, wherein the outer side (11A) of the wall (11) extends convexly curving.

5. Packing according to claim 1, wherein the outer side (11A) of the wall (11) extends concavely curving at the part (23) of the wall (11) which is closest to the rail (7) and extends convexly curving at the part (22) of the wall (11) which is closest to the sealing surface (12).

6. Packing according to claim 1, wherein the wall (11) has a thickness that tapers from the ends (28) of the wall to the middle (29) of the wall (11).

7. Packing according to claim 1, wherein the resilient member (20) has two uniform walls (11) arranged reversed opposite each other and forming a cavity (26) between two sealing surfaces (12).

8. Packing according to claim 7, wherein the walls (11) are connected by reinforcements (25) extending through the cavity (26) from one wall (11) to the other opposing wall (11)

9. Packing according to claim 8, wherein the reinforcements (25) are plate-shaped and an integrated part of the member (20) and moulded of the same material as the walls (11).

10. Packing according to claim 7, wherein the rail (7) extends into the cavity (26) and is broken into sections (27) at the part provided in the cavity (26) to enable bending towards the sealing surfaces (12).
